(19) United States
(12) Patent Application Publication
(10) Pub. No.: US 2003/0078685 A1
(43) Pub. Date: Apr. 24, 2003

(54) Intellegent transmitter receiver system and its operation method

(76) Inventor: Taddy Shao, Taipei (TW)

Correspondence Address: Taddy Shao, No. 34, Lane 87, Fu I Street, Chi Tu, Keelung, 206, TW

(21) Appl. No.: 09/982,397

(22) Filed: Oct. 19, 2001

(51) Int. Cl. G05B 15/00

(52) U.S. Cl. 700/75

(57) ABSTRACT

An intelligent transmitter receiver system is constructed to include a CPU, a data-entry keys input circuit, data-entry keys function switch, a DC battery circuit, a DC voltage rectifier circuit, a memory, an indicator lamp circuit, a digital-to-analog converter, a voltage-controlled type high frequency transmitting circuit, a bandwidth extension switching circuit, a mixer circuit, a signal amplifier, a full-channel signal receiving circuit, and a power supply circuit. The bandwidth extension switching circuit extends the working range of the transmitter receiver system. Frequency auto-correction is operated after reading of external code signal so that the efficiency of the system is improved.

### BACKGROUND OF THE INVENTION

The present invention relates to an intelligent transmitter receiver system and, more particularly to a simple, high-performance intelligent transmitter receiver system, which has the capability of copy-learning high-frequency remote controllers.

Regular receivers used in cars, motorcycles, rolling steel doors, etc., commonly have internal codes programmed therein. When the corresponding remote controller is lost, the user must go to the original supplier to check the internal codes of the cars, motorcycles, rolling steel doors, etc. In order to eliminate this problem, a user generally prepares multiple remote controllers (transmitters) for use with one receiver. When copying a remote controller, it needs special techniques and instrument, i.e., the case of a new remote controller must be opened at first so that a programmer can be connected to the bus line of the new remote controller for the input of the set frequency code into the new remote controller Only the persons skilled in the art can do the job.

Recently, remote controllers with a copy function have been developed, and have appeared on the market. This copy function enables the user to copy the frequency and code from one remote controller to another. However, because frequency error is inevitable according to this copy function, it is necessary to correct the transmitting frequency by means testing the main unit after copy of the frequency and code. This frequency correction procedure takes much time. According to conventional methods, it scans from the lowest frequency level to the highest frequency level at a low speed when receiving external frequency. This scanning procedure takes several tends of seconds when copying the code of one key. Because the transmitting wave of an external remote controller is of intermittent type, a miss of scan may occur. In this case, the scanning action must be repeated again. It takes too much time when copying the codes of several function keys.

Because the transmitting wave of an external remote controller is of intermittent type, the code arrangement and density are different, as shown in FIG. 1a. According to the aforesaid code copy operation, the input of code must be started only after the input of frequency. The remote controller scans the external code signal from low frequency toward high frequency, and the scanning speed shouldn't be too fast. The transmitting frequency of regular remote controllers is within 0˜500 MHz. If the external frequency is 380 MHz, the scanning speed is at 0.1 MHz/0.1 second. If the scanning speed is set faster, it cannot effectively scan the external frequency, as shown in FIG. 1b. Because a mixed frequency can be produced only when matched with the wave of the external code and, because the waveform of the external remote controller is unstable, the scanning speed must be as slow as shown in FIG. 1c so that the correct frequency can be scanned and the wave of the external code can be matched to produce a mixed frequency. According to test, copying the code of a function key takes about 20 seconds. If the frequency of the external remote controller is 450 MHz, it requires more than 20 seconds to complete the copy of the code of one function key. Further, because regular bandwidth of 100 MHz surpasses the set bandwidth, it is necessary to manually change the pin positions in changing the bandwidth. When a mixed frequency not obtained at a first scan, a secondary scanning produce must be run.

Further, different external remote controllers have different frequency designs, for example, 300 MHz in more US made remote controllers, 434 MHz in most European remote controllers, or 200˜500 MHz in other areas. In order for different frequency copy requirements, the circuit board is provided with pins for manually changing the bandwidth. This complicates the copy operation.

### SUMMARY OF THE INVENTION

The present invention has been accomplished under the circumstances in view. It is the main object of the present invention to provide an intelligent transmitter receiver system, which can copy the frequency and code of an external remote controller efficiently rapidly.

It is another object of the present invention to provide an intelligent transmitter receiver system, which uses a bandwidth extension switching circuit to extend the bandwidth of receivable range, eliminating the complicated conventional procedure of manually changing the pin positions in changing the bandwidth.

It is still another object of the present invention to provide an intelligent transmitter receiver system, which enables the CPU to drive the digital-to-analog converter to the high frequency transmitting circuit and the bandwidth extension switching circuit, to mix the internal oscillation frequency with the external serial signal after the signal receiving circuit has stored the code of the external remote controller in the memory, so that the code of the external remote controlled is copied at first and then the correction of the frequency of the code is achieved after the copy action.

It is still another object of the present invention to provide an intelligent transmitter receiver system, which drives the CPU to turn on the high frequency transmitting circuit to start wave mixing operation only after the full-frequency receiving circuit has successfully read the serial wave, so as to save power consumption and accelerate copy action.

### BRIEF DESCRIPTION OF THE DRAWINGS

FIG. 1 is a schematic drawing showing the scanned wave and channel of a remote controller according to the prior art.

FIG. 2 is a circuit diagram of the present invention.

FIG. 3 is a circuit block diagram of the present invention.

FIG. 4 is a flowchart of the copy-learning mode according to the present invention.

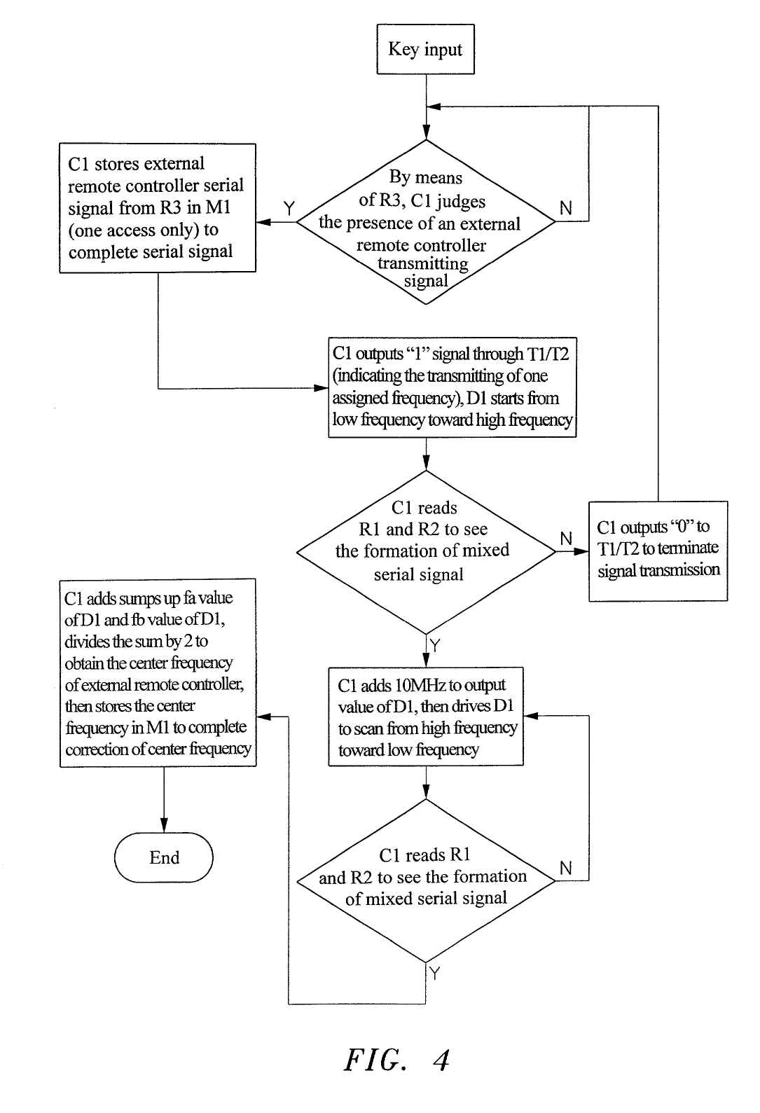

FIG. 5 illustrates signal waveforms obtained according to the present invention.

FIG. 6 is a flowchart of the code-transmitting mode according to the present invention.

### DETAILED DESCRIPTION OF THE PREFERRED EMBODIMENT

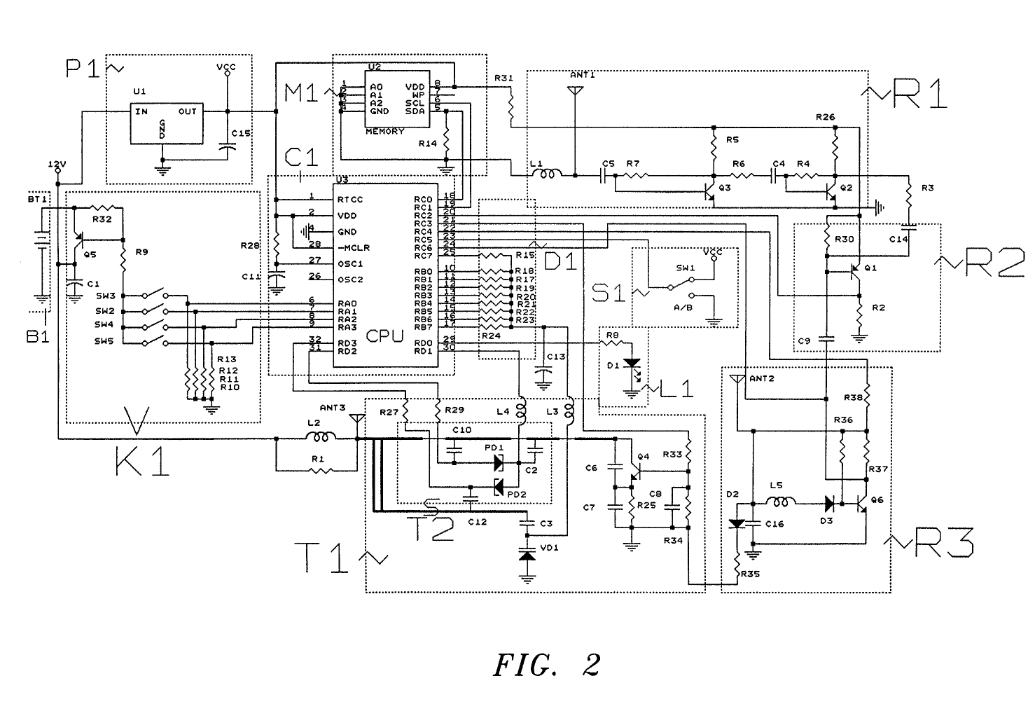

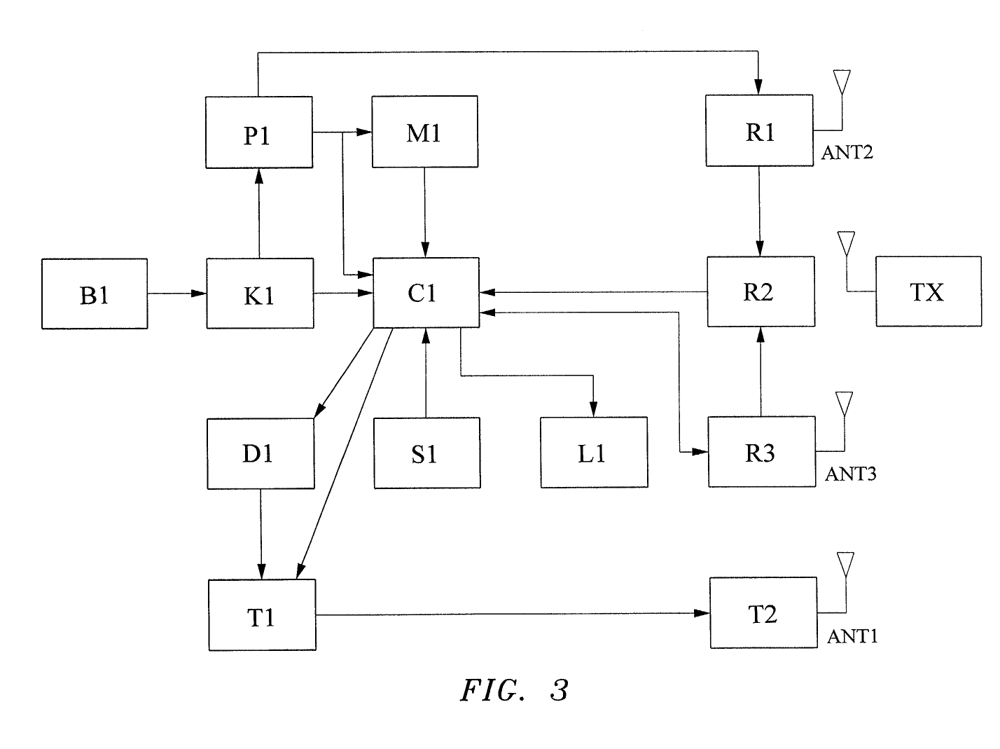

Referring to FIGS. 2 and 3, an intelligent transmitter receiver system in accordance with the present invention comprises:

a CPU C1 adapted to control instructions for the actions of code-transmitting mode and copy-learning mode;

a data-entry keys input circuit K1 adapted to input signal into the CPU C1;

a DC battery circuit B1 adapted to provide the necessary working power supply;

a DC voltage rectifier circuit P1 adapted to electrically connect a DC battery circuit B1 and convert the output power of the DC battery circuit B1 into the necessary working voltage for the other circuits of the intelligent transmitter receiver system when the push-button input circuit triggered;

a data-entry keys function switch S1 adapted to switch the data-entry keys of the data-entry keys input circuit K1 between two systems so as to multiply the functions of the data-entry keys;

a memory M1 adapted to store code data obtained by the CPU C1 and the center frequency value of the digital-to-analog converter D1;

an indicator lamp circuit L1 adapted to indicate current operation mode subject to the instruction of the CPU C1, for example, to keep the indicator lamp constantly on when at the code-transmitting mode, or to flash the indicator lamp when at the copy-learning mode;

a digital-to-analog converter D1 adapted to convert digital (parallel) signal into analog signal subject to the instruction of the CPU C1, so as to further drive a voltage-control type high-frequency transmitting circuit T1 to change its output oscillation frequency;

a voltage-controlled type high frequency transmitting circuit T1 adapted to transmit an oscillation frequency subject to the control of the CPU C1 and the digital-to-analog converter D1;

a bandwidth extension switching circuit T2 adapted to extend the bandwidth of the voltage-controlled type high frequency transmitting circuit T1 by 2˜3 times.

a mixer circuit R1 adapted to mix the wave from the internal high-frequency transmitting circuit T1 with the wave from the external remote controller, enabling the signal to be outputted only when wave mixing achieved;

a signal amplifier R2 adapted to amplify the signal from the mixer circuit R1 or the signal from a full-channel receiving circuit R3 into a digital serial signal receivable to the CPU C1; and

a full-channel signal receiving circuit R3 adapted to receive external series signal and to output received series signal to the CPU C1 for rapid center frequency correction.

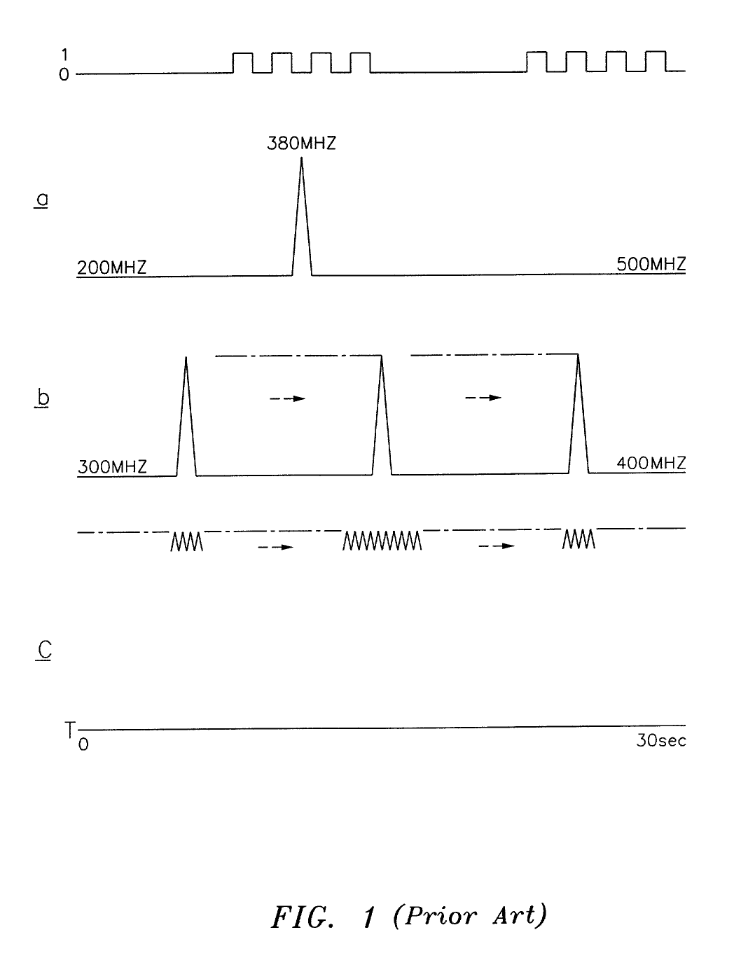

The aforesaid bandwidth extension switching circuit T2 comprises frequency switching diodes PD1 and PD2 for extending the original bandwidth by 2˜4 times. The usable bandwidth shown in FIG. 1 is within 300˜400 MHz. By means of the operation of the frequency range extension switching circuit T2, the bandwidth is extended to 250˜460 MHz.

Referring to FIGS. from 2 through 4, when the user presses on the copy control key K1 of the learning remote controller, the CPU C1 drives the full-channel receiving circuit R3 to judge if there is any signal from an external remote controller, and at the same time the indicator lamp circuit L1 flashes, informing the user that the learning mode is in function. If there is no signal from an external remote controller at this time, the full-channel receiving circuit R3 keeps searching when the copy control key K1 maintained depressed. When a control key signal from an external remote controller detected, the external code is read into the memory M1 within 0.5 second. After the action of code reading, it enters the step of frequency auto-correction. At this time, the counting value of the digital-to-analog converter D1 is zeroed (counting up from low frequency to high frequency), and the CPU C1 reads serial signal from the full-channel receiving circuit R3 (the full-channel receiving circuit R3 receives a serial wave when there is an external transmission source). When the full-channel receiving circuit R3 received a serial wave, the CPU C1 goes to the high-frequency transmitting circuit T1 and the frequency range extension switching circuit T2 through the digital-to-analog converter D1 to mix the provided oscillation frequency with the serial wave obtained from the external controller, and then goes to the mixer circuit R1 and the signal amplifier R2 to read the mixed serial signal. At this time, the CPU C1 can also drives the signal amplifier R2 to directly read the complete serial signal and store the signal in the memory M1.

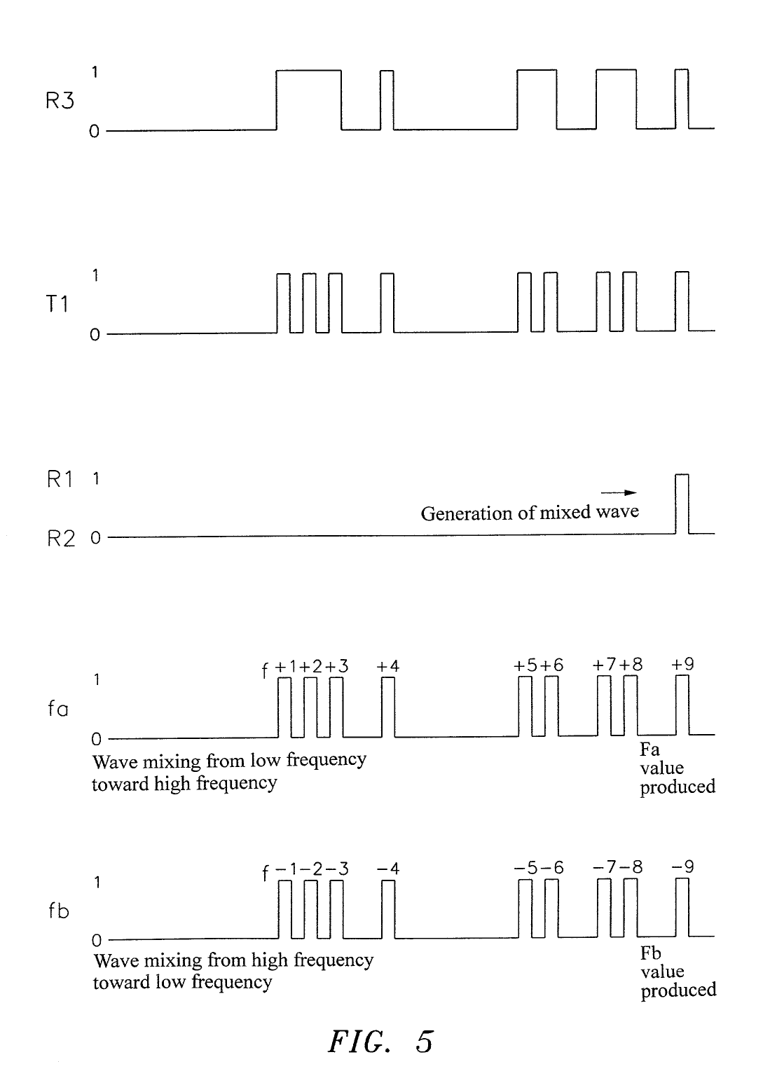

When a mixed wave detected (i.e., the mixer circuit R1 and the signal amplifier R2 have a serial signal), it means that the oscillation frequency of the high-frequency transmitting circuit T1 is about equal to the signal from the external remote controller, and the CPU C1 stores the value of the digital-to-analog converter D1 by fa, as shown in FIG. 5, and then adds 20 MHz to the frequency value of the digital-to-analog converter D1. The auto-correction action to correct the value from high frequency to low frequency is repeated until the production of a second mixed wave, i.e., obtaining the value fb. At final, the CPU C1 sums up the value of fa and the value of fb, and then divided the sum by 2 to obtain the, mean value for the center frequency of the external remote controller.

If no mixed wave is obtained, it repeats the aforesaid frequency auto-correction action.

When correcting (scanning) the frequency, the CPU C1 reads the serial wave from the full-channel receiving circuit R3, and then turns on the voltage-controlled type high frequency transmitting circuit T1 to start wave mixing operation. It saves power consumption because the voltage-controlled type high frequency transmitting circuit T1 is not constantly turned on.

Under the functioning of the mixer circuit R1, the signal amplifier R2, the full-channel receiving circuit R3, the voltage-controlled type high frequency transmitting circuit T1, and the digital-to-analog converter D1, the wave mixing action is accurately achieved without waste of time, eliminating the time-wasting drawback of the conventional blind scanning method of starting wave mixing action only when matched with the 0/1 intermittent serial wave of an external remote controller.

The 0/1 intermittent serial wave signal of an external remote controller has more than one thousands intermittent waves per second. The invention uses the full-channel receiving circuit R3 to achieve wave mixing precisely. It takes less than 3 seconds to complete the copy and frequency auto-correction of the code data of one data-entry key. Therefore, the invention greatly improves the efficiency and convenience of the action of copy.

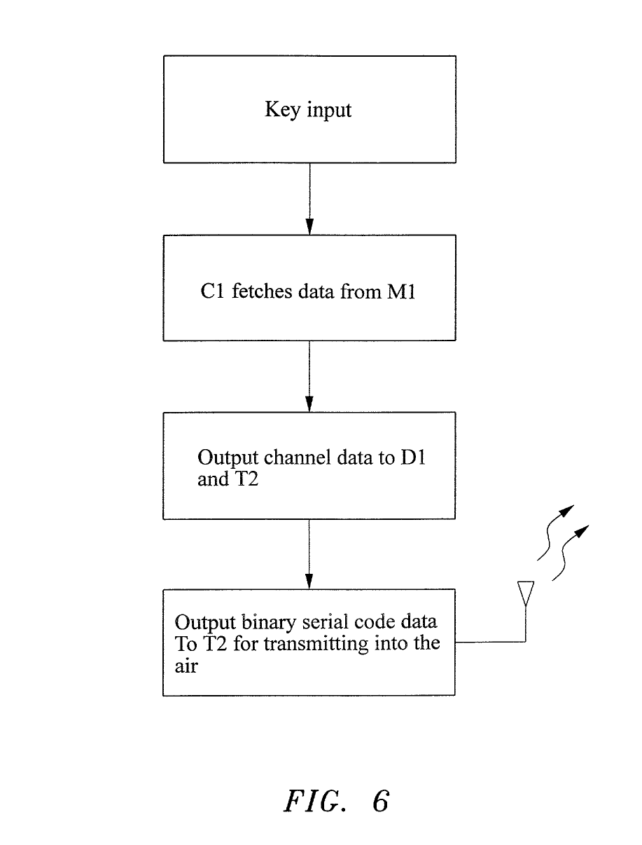

When entered the transmitting mode, as shown in FIG. 6, the CPU C1 detects the triggering of the key switch SW2, SW3, SW4, or SW5 of the data-entry keys input circuit K1, and then fetches the corresponding code data and transmitting frequency value from the memory M1, and then turns the indicator lamp of the indicator lamp circuit L1 into the state of constantly on to indicate the current transmitting mode, and then outputs the fetched transmitting frequency value to the digital-to-analog converter D1 and the frequency range extension switching circuit T2, so as to further output the code data to the voltage-controlled type high frequency transmitting circuit T1, enabling the assigned frequency to be transmitted to the main unit to control the rolling steel door, car lock, motorcycle lock, etc.

In order to save key space and to minimize the remote controller dimensions, the data-entry keys function switch S1 is provided, as shown in FIG. 2. When switching the data-entry keys function switch S1 from a first position to a second position, the data-entry keys are shifted to a second control system. By means of switching the data-entry keys function switch S1, the data-entry keys are shifted between two control systems.

As indicated above, the present invention greatly expands the scanning bandwidth. By means of the action of reading the code at the first time and then automatically correct the frequency, the invention is free from the limitation of the external bandwidth.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An intelligent transmitter receiver system comprising:
a CPU (central processing unit) adapted to control instructions for the actions of code-transmitting mode and copy-learning mode;
a data-entry keys input circuit adapted to input signal into said CPU;
a DC battery circuit adapted to provide the necessary working power supply;
a DC voltage rectifier circuit adapted to electrically connect a DC battery circuit and convert the output power of the DC battery circuit into the necessary working voltage;
a memory adapted to store code data obtained by said CPU and the center frequency value of said digital-to-analog converter;
an indicator lamp circuit adapted to indicate current operation mode subject to the instruction of said CPU by maintaining indicator lamp means thereof constantly on when at the code-transmitting mode, or flashing said indicator lamp means when at the copy-learning mode;
a digital-to-analog converter adapted to convert digital (parallel) signal into analog signal subject to the instruction of said CPU, so as to further drive a voltage-control type high-frequency transmitting circuit to change output oscillation frequency;
a voltage-controlled type high frequency transmitting circuit adapted to transmit an oscillation frequency subject to the control of said CPU and said digital-to-analog converter;
a bandwidth extension switching circuit adapted to extend the bandwidth of said voltage-controlled type high frequency transmitting circuit;
a mixer circuit adapted to mix the wave from said internal high-frequency transmitting circuit with the wave from an external remote controller, enabling the signal to be outputted only when wave mixing achieved;
a signal amplifier adapted to amplify signal from said mixer circuit and signal from a full-channel receiving circuit into a digital serial signal receivable to said CPU; and
a full-channel signal receiving circuit adapted to receive external series signal and to output received series signal to said CPU for rapid center frequency correction.

2. The intelligent transmitter receiver system as claimed in claim 1 wherein said CPU is adapted to drive said signal amplifier to store fetched serial signal in said memory.

3. The intelligent transmitter receiver system as claimed in claim 1 wherein said CPU fetches serial wave from said full-channel signal receiving circuit during frequency correction (scanning), and then turns on said voltage-controlled type high frequency transmitting circuit to start wave mixing operation.

4. The intelligent transmitter receiver system as claimed in claim 1 further comprising a data-entry keys function switch adapted to switch data-entry keys of said data-entry keys input circuit between two systems so as to double the functions of data-entry keys of said data-entry keys input circuit.

5. The intelligent transmitter receiver system as claimed in claim 1 wherein said bandwidth extension switching circuit is comprised of at least one frequency switching diode.

6. An intelligent transmitter receiver system operation method used in the intelligent transmitter receiver system of claim 1, comprising a copy-learning mode and a code-transmitting mode, said copy-learning mode comprising the steps of:
a. driving said CPU to give an instruction to said full-frequency signal receiving circuit, causing said full-frequency signal receiving circuit to scan the presence of a code signal transmitted from an external remote controller when said data-entry keys input circuit is on;
b. driving said indicator lamp circuit to flash, informing the user of the effectiveness of the copy-learning mode;
c. storing the scanned code signal of the external remote controller into said memory circuit;
d. correcting the frequency;
e. driving said digital-to-analog converter to start counting from low frequency toward high frequency and reading in the serial wave received by said full-channel signal receiving circuit;
f. turning on said voltage-controlled type high frequency transmitting circuit to start wave mixing operation;
g. driving said CPU to go to said high-frequency transmitting circuit and said frequency range extension switching circuit through said digital-to-analog converter to mix provided oscillation frequency with the serial wave obtained from the external controller, and then to go to said mixer circuit and said signal amplifier to read the mixed serial signal;
h. driving said CPU to store the value of said digital-to-analog converter, and then to increase the frequency value of said digital-to-analog converter, and then to correct the frequency value of said digital-to-analog converter from high frequency to low frequency until the production of a second mixed wave, and then to obtain the mean value; and
i. storing the center frequency thus obtained in said memory;
said code-transmitting mode comprising the steps of:
A. driving said CPU to scan the triggering of key switches of said data-entry keys input circuit;
B. driving said CPU to fetch the corresponding code data and transmitting frequency value from said memory subject to the key switch of said data-entry input circuit been triggered;
C. driving said indicator lamp circuit to give a signal indicative of the code-transmitting mode;
D. driving said CPU to output the fetched transmitting frequency value to said digital-to-analog converter and said frequency range extension switching circuit; and
E. driving said CPU to output the fetched code data to said voltage-controlled type high frequency transmitting circuit, enabling the assigned frequency to be transmitted to the unit been controlled.
